(19) United States
(12) Patent Application Publication
(10) Pub. No.: US 2008/0150920 A1
(43) Pub. Date: Jun. 26, 2008

(54) MULTI-DISPLAY SYSTEM AND METHOD FOR DISPLAYING VIDEO FRAMES THEREON

(76) Inventor: Hsueh-Bing Yen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/616,030

(22) Filed: Dec. 26, 2006

(51) Int. Cl. G09G 5/00; G09G 5/36; G06T 1/00

(52) U.S. Cl. 345/204; 345/1.1; 345/547; 345/522

(57) ABSTRACT

A multi-display system and method for displaying tearing free video frames thereon is disclosed. The present invention eliminates the conventional tearing defect by starting the pixel data updating of a display pattern after a last pixel of the display pattern has been displayed on a display device of the multi-display system having a lower refresh frequency, and pausing the pixel data updating of a specific pixel, which is not displayed on another display device of the multi-display system having a higher refresh frequency, until the specific pixel has been displayed.

### BACKGROUND OF THE INVENTION

1. Field of the Invention

The invention relates to a multi-display system and a method for displaying video frames thereon, and more particularly, to a multi-display system and a method for displaying tearing free video frames thereon.

2. Description of the Prior Art

Tearing is a display defect that typically occurs when a video frame is being updated in a display memory (e.g. a frame buffer) while a display controller is accessing the same portion of the display memory, for instance, to present the video frame onto a display apparatus, such as a cathode ray tube (CRT) monitor.

In other words, if the display controller accesses the video frame while a bit block transfer (BitBlt) engine is moving video frame data from an off-screen memory space to an on-screen memory space in the display memory, then a tearing defect will occur, where part of a current frame is visible and part of a previous frame is visible. Tearing defects are common not only to CRT monitors, but also across all display technology types such as LCD monitors.

Tearing defects may become particularly noticeable when rendering video frames of the same display memory on two monitors having different refresh frequencies or different scanning timings. It would be desirable to provide a system and a method for displaying video frames of the same display memory or different display memories on two or more display devices seamlessly between every video frame of display images, thereby eliminating tearing defects.

### SUMMARY OF THE INVENTION

It is therefore one of the objectives of the present invention to provide a multi-display system and a method for displaying tearing free video frames thereon, to solve the mentioned problem.

According to an embodiment of the present invention, a method for displaying video frames on at least two display devices respectively having a first refresh frequency and a second refresh frequency according to a plurality of current pixel data sets stored in a display memory is provided. Both the first refresh frequency and the second refresh frequency are slower than a memory clock rate of the display memory. The method comprises accessing the current pixel data sets to drive pixels at scan lines of a first active video area of a first display device in the display devices and pixels at scan lines of a second active video area of a second display device in the display devices. After a last pixel of the second display device that corresponds to a display pattern to be updated has been displayed on a video frame according to the current pixel data sets, starting updating the current pixel data sets utilizing update pixel data sets corresponding to the display pattern, and avoiding updating the current pixel data set of a specific pixel when the specific pixel is not yet displayed on the video frame of the first display device according to the current pixel data sets.

According to an embodiment of the present invention, a multi-display system for displaying video frames is provided. The multi-display system comprises a display memory, a first display device, a second display device, a first display controller, a second display controller, an updating circuit, and a processor. The display memory is for storing a plurality of current pixel data sets. The first display device is operated at a first refresh frequency, and has a first active video area. The second display device is operated at a second refresh frequency, and has a second active video area. The first display controller is coupled to the display memory and the first display device, and for accessing the current pixel data sets stored in the display memory to drive pixels at scan lines of the first active video area of the first display device. The second display controller is coupled to the display memory and the second display device, and for accessing the current pixel data sets stored in the display memory to drive pixels at scan lines of the second active video area of the second display device. The updating circuit is coupled to the display memory, and for updating the current pixel data sets in the display memory. The processor is coupled to the first display controller, the second display controller, and the updating circuit. The processor is for commanding the updating circuit to start updating the current pixel data sets utilizing update pixel data sets corresponding to a display pattern after a last pixel of the display pattern has been displayed on the second display device, and for pausing the pixel data updating of a specific pixel, which is not displayed on the first display device, until the specific pixel has been displayed.

According to another embodiment of the present invention, a multi-display system for displaying video frames is provided. The multi-display system comprises a display memory, a first display device, a second display device, a first display controller, a second display controller, an updating circuit, a processor, and a command buffer. The display memory is for storing a plurality of current pixel data sets. The first display device is operated at a first refresh frequency, and has a first active video area. The second display device is operated at a second refresh frequency, and has a second active video area. The first display controller is coupled to the display memory and the first display device, and for accessing the current pixel data sets stored in the display memory to drive pixels at scan lines of the first active video area of the first display device. The second display controller is coupled to the display memory and the second display device, and for accessing the current pixel data sets stored in the display memory to drive pixels at scan lines of the second active video area of the second display device. The updating circuit is coupled to the first display controller, the second display controller, and the display memory, and the updating circuit is for updating the current pixel data sets in the display memory. The processor is for issuing at least a command. The command buffer is coupled to the first display controller, the second display controller, the processor, and the updating circuit. The command buffer is for buffering the command from the processor, and then outputting the buffered command to the updating circuit to control the updating circuit to start updating the current pixel data sets utilizing a plurality of update pixel data sets corresponding to a display pattern after a last pixel of the display pattern has been displayed on the second display device. The updating circuit pauses the pixel data updating of a specific pixel, which is not displayed on the first display device, until the specific pixel has been displayed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of a multi-display system according to a first embodiment of the present invention.

FIG. 2 is a simplified block diagram of a multi-display system according to a second embodiment of the present invention.

FIG. 3 is a flow chart showing the method for displaying tearing free video frames on the multi-display system according to the embodiments of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

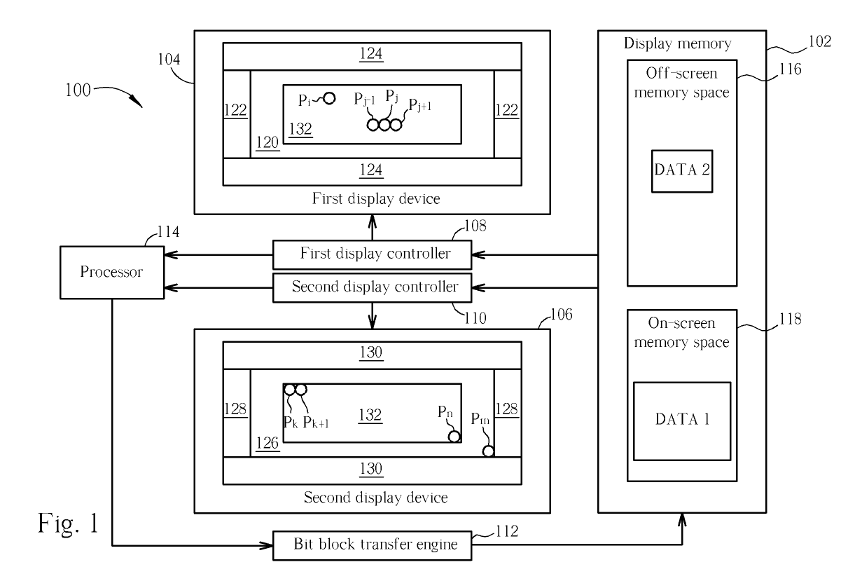

To explain the present invention multi-display system and method for displaying tearing free video frames thereon, please refer to FIG. 1. FIG. 1 is a simplified block diagram of a multi-display system 100 according to a first embodiment of the present invention. As shown in FIG. 1, the multi-display system 100 includes a display memory 102, a first display device 104, a second display device 106, a first display controller 108 coupled between the display memory 102 and the first display device 104, a second display controller 110 coupled between the display memory 102 and the second display device 106, a bit block transfer engine 112 coupled to the display memory 102, and a processor 114 coupled between the first display controller 108, the second display controller 110, and the bit block transfer engine 112.

The display memory 102 has an off-screen memory space 116 used for buffering a plurality of update pixel data sets DATA2 and an on-screen memory space 118 used for buffering a plurality of current pixel data sets DATA1, where the display memory 102 is operated at a memory clock rate. The display memory 102 can be a DRAM or Flash memory. However, the content mentioned above is only an illustration, and is not a limitation of the present invention. The first display device 104 has a plurality of scan lines each containing a plurality of pixels (not shown). In addition, as shown in FIG. 1, the first display device 104 includes a first active video area 120, a first horizontal blanking area 122 on the left side, a first horizontal blanking area 122 on the right side, a first vertical blanking area 124 on the top side, and a first vertical blanking area 124 on the bottom side. Similarly, the second display device 106 has a plurality of scan lines each containing a plurality of pixels (not shown). In addition, as shown in FIG. 1, the second display device 106 has a second active video area 126, a second horizontal blanking area 128 on the left side, a second horizontal blanking area 128 on the right side, a second vertical blanking area 130 on the top side, and a second vertical blanking area 130 on the bottom side. As known to those skilled in this art, the first display device 104 and the second display device 106 both display an image by scanning each scan line of pixel data horizontally, starting from the upper-left corner. After completing scanning an image field (i.e. a full screen), the scan point returns to the upper-left corner to begin scanning and displaying the next image field. Since the display operation is well known, further description is omitted here for brevity. The content mentioned above is only an illustration, and is not a limitation of the present invention.

In one exemplary embodiment, the first display device 104 is operated according to a first refresh frequency and the second display device 106 is operated according to a second refresh frequency, where the first refresh frequency may be different from the second refresh frequency. In another example, the first display device 104 is operated according to a first refresh frequency and the second display device 106 is operated according to a second refresh frequency, where the first refresh frequency is equal to the second refresh frequency but the scanning timings of the first display device and the second display device are different. The disclosed pixel data updating scheme can be applied to above cases, and will be described in detail later. Additionally, the first display device 104 and second display device 106 can be, for example, CRT monitors, LCD monitors, PDP monitors, PLED monitors, OLED monitors, or projectors, but this is not a limitation of the present invention. Both the first refresh frequency of the first display device 104 and the second refresh frequency of the second display device 106 are slower than the memory clock rate of the display memory 102 in this embodiment. For example, the memory clock rate of a DRAM can be 400 MHz, while the refresh frequency of a LCD monitor/CRT monitor is only about 60 Hz to 100 Hz.

The first display controller 108 is utilized for accessing the current pixel data sets DATA1 stored in the display memory 102 to drive the pixels at the scan lines of the first active video area 120 of the first display device 104. The second display controller 110 is utilized for accessing the current pixel data sets DATA1 stored in the display memory 102 to drive the pixels at the scan lines of the second active video area 126 of the second display device 106. The bit block transfer engine 112 is utilized for updating the current pixel data sets from the off-screen memory space 116 to the on-screen memory space 118 in the display memory 102. The bit block transfer engine 112 can be, for example, a 2D graphic drawing engine, a 3D graphic drawing engine, or a video engine, but this is not a limitation of the present invention. The processor 114 is utilized for commanding the bit block transfer engine 112 to start updating the current pixel data sets DATA1 utilizing update pixel data sets DATA1 or to pause updating the current pixel data sets DATA1.

Please note that the first refresh frequency of the first display device 104 and the second refresh frequency of the second display device 106 will be compared by the processor 114 at first to determine whether the first refresh frequency is higher than the second refresh frequency or the second refresh frequency is higher than the first refresh frequency. Known techniques can be adopted to identify which refresh frequency is higher. The operational details related to comparing the first refresh frequency of the first display device 104 and the second refresh frequency of the second display device 106 are well-known to those of average skill in this art, and therefore further explanation is omitted herein for the sake of brevity.

Next, the first display controller 108 and the second display controller 110 are utilized to access the current pixel data sets DATA1 in order to drive the pixels at the scan lines of the first active video area 120 of the first display device 104 to display an image corresponding to the current pixel data sets DATA1 and to drive the pixels at the scan lines of the second active video area 126 of the second display device 106 to display the same image corresponding to the current pixel data sets DATA1. As shown in FIG. 1, the displayed image includes a display pattern 132.

Suppose that, using any available means, the first refresh frequency of the first display device 104 is identified to be higher than the second refresh frequency of the second display device 106. After a last pixel Pₙ of the display pattern 132 to be updated has been displayed according to the current pixel data sets DATA1, the processor 114 is notified, for example, according to scanning information given by the second display controller 118. As shown in FIG. 1, a pixel Pi is displayed on the first display device 104 when the pixel Pₙ is displayed on the second display device 106. Next, the processor 114 will command the bit block transfer engine 112 to start updating the current pixel data sets DATA1 utilizing update pixel data sets DATA2. It should be noted that a portion of data in the current pixel data sets DATA1 that corresponds to the display pattern 132 will be replaced by the update pixel data sets DATA2. The update pixel data sets DATA2 are accessed from the off-screen memory space 116 according to the memory clock rate, and then each update pixel data set overwrites a corresponding current pixel data set in the on-screen memory space 118 according to the memory clock rate. For example, a current pixel data set corresponding to a pixel Pₖ located at a top-left corner of the display pattern 132 is firstly updated, and then a current pixel data set corresponding to an adjacent pixel Pₖ₊₁ is updated. Following the above rule, the pixel data is updated pixel by pixel and line by line. The content mentioned above is only an illustration, and is not a limitation of the present invention.

Additionally, after the pixel data updating is activated, the processor 114 refers to the scanning information given by the first display controller 108 to avoid updating a current pixel data set of a specific pixel Pⱼ when the specific pixel Pⱼ is not yet displayed on the first active video area 120 of the first display device 104 where a previous pixel Pⱼ₋₁ has been displayed. At this moment, the processor 114 will command the bit block transfer engine 112 to pause updating the current pixel data set of the specific pixel Pⱼ until the first display controller 108 has controlled the first display device 104 to display the specific pixel Pⱼ according to the current pixel data set read from the on-screen memory space 118. Obviously, the conventional tearing defect is eliminated by starting the pixel data updating of a display pattern after a last pixel of the display pattern has been displayed on a display device having lower refresh frequency, and pausing the pixel data updating of a specific pixel, which is not displayed on a display device having higher refresh frequency, until the specific pixel has been displayed. Referring to FIG. 1, since the memory clock rate of the display memory 102 is far greater than the first refresh rate of the first display device 104, the pixel data updating is paused after the update pixel data set corresponding to the pixel Pⱼ has been written to the on-screen memory space 118 because the next pixel Pⱼ₊₁ is not displayed utilizing a corresponding current pixel data set. The above operation is repeated until a current pixel data set of a last pixel of the display pattern has been updated after the display of the last pixel.

Please note that, in the above embodiment, the pixel data updating of the display pattern 132 is started when the last pixel Pₙ has been displayed on the second display device 106 having a lower refresh frequency. However, in other embodiments, the timing of starting the pixel data updating can be selected to be any time after the pixel Pₙ in a current video frame is displayed but before the pixel Pₖ in a next video frame is displayed. For example, in one embodiment of the present invention, the pixel data updating of the display pattern 132 is started when entering the second horizontal blanking area 128 corresponding to a last scan line of the second active video area 126 of the second display device 106 (i.e. after the pixel Pₘ is displayed). In another embodiment, the pixel data updating of the display pattern 132 is started when entering the second vertical blanking area 130 corresponding to the second active video area 126 of the second display device 106.

It should be noted that the disclosed pixel data updating scheme can be applied to any display patterns regardless of their size. For example, suppose that the display pattern 132 to be updated is a full screen, i.e. the display pattern 132 occupies the whole second active video area 126 of the second display device 106 where pixel Pₙ is now pixel Pₘ. Based upon the above disclosure, the pixel data updating is started after the pixel Pₘ has been displayed. In other words, the pixel data updating is started when entering the second horizontal blanking area 128 corresponding to a last scan line of the second active video area 126 of the second display device 106. In an alternative design, the pixel data updating is started when entering the second vertical blanking area 130 corresponding to the second active video area 126 of the second display device 106. All of the above embodiments obey the spirit of the present invention and fall within the scope of the present invention.

In a case where the first refresh frequency of the first display device 104 is lower than the second refresh frequency of the second display device 106, it is readily understood that conventional tearing defects are eliminated by starting the pixel data updating of a display pattern after a last pixel of the display pattern has been displayed on a display device having lower refresh frequency, and pausing the pixel data updating of a specific pixel, which is not displayed on a display device having higher refresh frequency, until the specific pixel has been displayed. Since the pixel data updating operation has been described in detail above, further description is omitted for brevity.

In a case where a refresh frequency of one display device is equal to a refresh frequency of another display device and scanning timings of these two display devices are different, the present invention will identify one of the display devices as the first display device and another of the display devices as the second display device randomly. Similarly, it is readily understood that conventional tearing defects are eliminated by starting the pixel data updating of a display pattern after a last pixel of the display pattern has been displayed on a first/second display device, and pausing the pixel data updating of a specific pixel, which is not displayed on a second/first display device, until the specific pixel has been displayed. Since the pixel data updating operation has been described in detail above, further description is omitted for brevity.

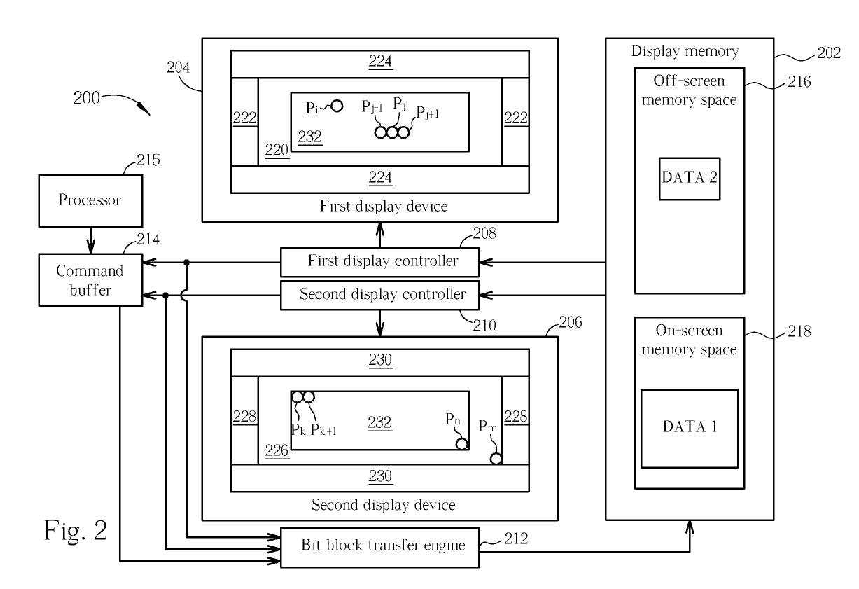

Please refer to FIG. 2. FIG. 2 is a simplified block diagram of a multi-display system 200 according to a second embodiment of the present invention. As shown in FIG. 2, the multi-display system 200 includes a display memory 202, a first display device 204, a second display device 206, a first display controller 208 coupled between the display memory 202 and the first display device 204, a second display controller 210 coupled between the display memory 202 and the second display device 206, a bit block transfer engine 212 coupled to the display memory 202, a command buffer 214 coupled to the first display controller 208, the second display controller 210, and the bit block transfer engine 212, and a processor 215 coupled to the command buffer 214. Please note that the components of the same name in the embodiments shown in FIG. 1 and FIG. 2 have the same operation and functionality. Therefore, the description is not repeated here for brevity.

The difference between the multi-display systems 100 and 200 is the implementation of the command buffer 214. The command buffer 214 is utilized for buffering commands issued from the processor 215, and then outputting buffered commands to the bit block transfer engine 212 when respective conditions are met. For example, in this embodiment the processor 215 stores commands into the command buffer 214 in advance so that the processor 215 can be utilized more efficiently, for example, the processor 215 is allowed to process other tasks after each command related to pixel data updating is inputted to the command buffer 214. The processor 215 is configured to generate command(s) used for instructing the bit block transfer engine 212 to start the aforementioned pixel data updating process. The command buffer 214 is configured to output its buffered command(s) according to scanning information given by a display controller of a display device having lower refresh frequency. The bit block transfer engine 212 is configured to pause or resume the pixel data updating according to scanning information given by a display controller of a display device having higher refresh frequency.

In a case where the first refresh frequency of the first display device 204 is higher than the second refresh frequency of the second display device 206, if the last pixel of a display pattern 232 to be updated is Pₙ, the processor 215 generates a specific command used to instruct the bit block transfer engine 212 to start updating current pixel data sets of the display pattern 232 when the pixel Pₙ has been displayed on the second display device 206, and then stores this specific command, containing information of the pixel Pₙ, into the command buffer 214. Next, the command buffer 214 determines whether this buffered specific command is outputted to the bit block transfer engine 212 according to the scanning information given by the second display controller 210. For example, the command buffer compares information of the last pixel Pₙ given by the specific command and information of the currently displayed pixel, and outputs the buffered specific command to the bit block transfer engine 212 to activate the pixel data updating when the scanning information indicates that the currently displayed pixel is the last pixel Pₙ. After the pixel data updating is activated due to the specific command, the bit block transfer engine 212 refers to the scanning information given by the first display controller 208 to avoid updating a current pixel data set of a specific pixel Pⱼ when the specific pixel Pⱼ is not displayed on the first active video area 220 of the first display device 204 yet. After reading the mentioned operation of the multi-display system 100 shown in FIG. 1, a person skilled in this art can readily understand that the pixel data updating concept applied in the multi-display system 200 shown in FIG. 2 is identical to that adopted in the multi-display system 100. That is, the rule of starting the pixel data updating and the rule of pausing the pixel data updating adopted by the multi-display system 200 are both the same as that mentioned above. Further description is omitted here for brevity.

In another case where the first refresh frequency of the first display device 204 is lower than the second refresh frequency of the second display device 206, the command buffer 214 outputs its buffered command(s) according to the scanning information given by the first display controller 208 instead. The bit block transfer engine 212 refers to the scanning information given by the second display controller 210 instead to pause and resume the pixel data updating.

In a case where a refresh frequency of one display device is equal to a refresh frequency of another display device and scanning timings of these two display devices are different, the present invention will identify one of the display devices as the first display device and another of the display devices as the second display device randomly. The rule of starting the pixel data updating and the rule of pausing the pixel data updating adopted by the multi-display system 200 are the same as that mentioned above. Further description is omitted here for brevity.

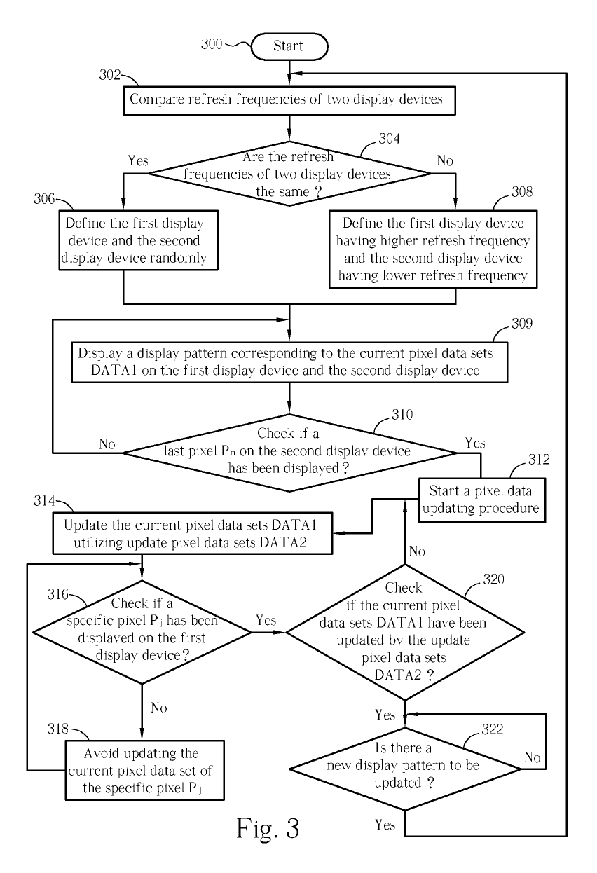

To summarize the present invention method concisely, please refer to FIG. 3. FIG. 3 is a flow chart showing the method for displaying tearing free video frames on the multi-display system according to the embodiments of the present invention.

Step 300: Start.

Step 302: Compare refresh frequencies of two display devices.

Step 304: Are the refresh frequencies of two display devices the same? If yes, go to step 306; otherwise, go to step 308.

Step 306: Identify one of the display devices as the first display device and another of the display devices as the second display device randomly. Go to step 309.

Step 308: Identify one of the display devices having higher refresh frequency as the first display device and another of the display devices having lower refresh frequency as the second display device. Go to step 309.

Step 309: Access the current pixel data sets DATA1 in order to drive the pixels at the scan lines of the first active video area of the first display device to display a display pattern corresponding to the current pixel data sets DATA1 and the pixels at the scan lines of the second active video area of the second display device to display the display pattern corresponding to the current pixel data sets DATA1.

Step 310: Check if a last pixel Pₙ of a display pattern to be updated on the second active video area of the second display device has been displayed according to the current pixel data sets DATA1. If yes, go to step 312; otherwise, repeat step 310 to keep monitoring if the last pixel Pₙ has been displayed.

Step 312: Start a pixel data updating procedure.

Step 314: Update the current pixel data sets DATA1 utilizing update pixel data sets DATA2 corresponding to the display pattern to be updated.

Step 316: Check if a specific pixel Pⱼ has been displayed on the first active video area of the first display device before updating a current pixel data set of the specific pixel Pⱼ. If yes, go to step 320; otherwise, go to step 318.

Step 318: Avoid updating the current pixel data set of the specific pixel Pⱼ. Go to step 316 to keep monitoring if the specific pixel Pⱼ has been displayed.

Step 320: Check if the current pixel data sets DATA1 corresponding to the display pattern have been updated by the update pixel data sets DATA2. If yes, go to step 322; otherwise, go to step 314.

Step 322: Is there a new display pattern to be updated? If yes, go to step 302; otherwise, repeat step 322 to keep monitoring if there is any display pattern to be updated.

Please note that the last pixel Pₙ mentioned in the flow can be replaced by the pixel Pₘ in the case where the display pattern occupies the whole second active video area of the second display device or the whole first active video area of the first display device. The method mentioned above is only an illustration, and is not a limitation of the present invention.

Briefly summarized, the present invention offers a multi-display system and a method for displaying tearing free video frames thereon. Compared with the prior art, the present invention method can always display a complete video frame on two display devices, and therefore the tearing defect of the prior art is solved by the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying video frames on at least two display devices respectively having a first refresh frequency and a second refresh frequency, the method comprising the steps of:
accessing a plurality of current pixel data sets to drive pixels at scan lines of a first active video area of a first display device in the display devices and pixels at scan lines of a second active video area of a second display device in the display devices; and
updating the current pixel data sets utilizing a plurality of update pixel data sets corresponding to the display pattern, and avoiding updating the current pixel data set of a specific pixel when the specific pixel is not yet displayed on the video frame of the first display device according to the current pixel data sets after a last pixel of the second display device that corresponds to a display pattern to be updated has been displayed on a video frame according to the current pixel data sets.

2. The method of claim 1, further comprising:
comparing the first refresh frequency and the second refresh frequency; and
identifying one of the display devices having the first refresh frequency as the first display device, and identifying another of the display devices having the second refresh frequency as the second display device if the first refresh frequency is higher than the second refresh frequency.

3. The method of claim 1, further comprising:
comparing the first refresh frequency and the second refresh frequency; and
identifying one of the display devices as the first display device and another of the display devices as the second display device if the first refresh frequency is equal to the second refresh frequency and scanning timings of the first display device and the second display device are different.

4. The method of claim 1, wherein the step of updating the current pixel data sets comprises the steps of:
updating the current pixel data sets when entering a horizontal blanking area corresponding to a last scan line of the second active video area.

5. The method of claim 1, wherein the step of updating the current pixel data sets comprises the steps of:
starting updating the current pixel data sets when entering a vertical blanking area corresponding to a last scan line of the second active video area.

6. A multi-display system for displaying video frames, comprising:
a display memory, for storing a plurality of current pixel data sets;
a first display device, operated at a first refresh frequency, and having a first active video area;
a second display device, operated at a second refresh frequency, the second display device having a second active video area;
a first display controller, coupled to the display memory and the first display device, for accessing the current pixel data sets stored in the display memory in order to drive pixels at scan lines of the first active video area of the first display device;
a second display controller, coupled to the display memory and the second display device, for accessing the current pixel data sets stored in the display memory in order to drive pixels at scan lines of the second active video area of the second display device;
an updating circuit, coupled to the display memory, for updating the current pixel data sets in the display memory; and
a processor, coupled to the first display controller, the second display controller, and the updating circuit, for commanding the updating circuit to update the current pixel data sets utilizing update pixel data sets corresponding to a display pattern after a last pixel of the display pattern has been displayed on the second display device, and for pausing the pixel data updating of a specific pixel that is not displayed on the first display device, until the specific pixel has been displayed.

7. The multi-display system of claim 6, wherein the display memory further stores the update pixel data sets.

8. The multi-display system of claim 6, wherein the first display device further comprises a first horizontal blanking area and a first vertical blanking area.

9. The multi-display system of claim 6, wherein the second display device further comprises a second horizontal blanking area and a second vertical blanking area.

10. The multi-display system of claim 9, wherein the processor controls the updating circuit to update the current pixel data sets when the second horizontal blanking area corresponding to a last scan line of the second active video area is entered.

11. The multi-display system of claim 9, wherein the processor controls the updating circuit to update the current pixel data sets when the second vertical blanking area corresponding to the second active video area is entered.

12. The multi-display system of claim 6, wherein the processor is further integrated with at least one of the first display device and the second display device.

13. The multi-display system of claim 6, wherein the processor further compares the first refresh frequency and the second refresh frequency; and identifies the display device having the first refresh frequency as the first display device and the display device having the second refresh frequency as the second display device if the first refresh frequency is higher than the second refresh frequency.

14. The multi-display system of claim 6, wherein the processor further compares the first refresh frequency and the second refresh frequency; and identifies one of the display devices as the first display device and another of the display devices as the second display device if the first refresh frequency is equal to the second refresh frequency and scanning timings of the first display device and the second display device are different.

15. The multi-display system of claim 6, wherein the processor detects whether the last pixel of the second display device that corresponds to the display pattern to be updated has been displayed according to scanning information given by the second display controller.

16. The multi-display system of claim 6, wherein the processor detects whether the specific pixel has been displayed on the video frame of the first display device yet according to scanning information given by the first display controller.

17. A multi-display system for displaying video frames, comprising:
a display memory, for storing a plurality of current pixel data sets;
a first display device, operated at a first refresh frequency, the first display device having a first active video area;
a second display device, operated at a second refresh frequency, the second display device having a second active video area;
a first display controller, coupled to the display memory and the first display device, for accessing the current pixel data sets stored in the display memory to drive pixels at scan lines of the first active video area of the first display device;
a second display controller, coupled to the display memory and the second display device, for accessing the current pixel data sets stored in the display memory to drive pixels at scan lines of the second active video area of the second display device;
an updating circuit, coupled to the first display controller, the second display controller, and the display memory, for updating the current pixel data sets in the display memory;
a processor, for issuing at least a command; and
a command buffer, coupled to the first display controller, the second display controller, the processor, and the updating circuit, operative to buffer the command from the processor, and then output the buffered command to the updating circuit to control the updating circuit to start updating the current pixel data sets utilizing a plurality of update pixel data sets corresponding to a display pattern after a last pixel of the display pattern has been displayed on the second display device;
wherein the updating circuit pauses the pixel data updating of a specific pixel, which is not displayed on the first display device, until the specific pixel has been displayed.

18. The multi-display system of claim 17, wherein the second display device further comprises a second horizontal blanking area and a second vertical blanking area.

19. The multi-display system of claim 18, wherein the command buffer outputs the buffered command to control the updating circuit to start updating the current pixel data sets when the second horizontal blanking area corresponding to a last scan line of the second active video area is entered.

20. The multi-display system of claim 18, wherein the command buffer outputs the buffered command to control the updating circuit to start updating the current pixel data sets when the second vertical blanking area corresponding to the second active video area is entered.

21. The multi-display system of claim 17, wherein the command buffer outputs the buffered command according to scanning information given by the second display controller.

22. The multi-display system of claim 17, wherein the updating circuit pauses the pixel data updating of the specific pixel according to scanning information given by the first display controller.
